(19) United States
(12) Patent Application Publication
(10) Pub. No.: US 2010/0171074 A1
(43) Pub. Date: Jul. 8, 2010

(54) LIQUID CRYSTAL MIXTURE

(75) Inventors: YU-YING HSIEH, KAOHSIUNG COUNTY (TW); SHU-LING LO, KAOHSIUNG COUNTY (TW)

Correspondence Address: YOUNG & THOMPSON, 209 Madison Street, Suite 500, Alexandria, VA, 22314, US

(73) Assignee: DAILY POLYMER CORP., KAOHSIUNG HSIEN (TW)

(21) Appl. No.: 12/350,406

(22) Filed: Jan. 8, 2009

(51) Int. Cl. C09K 19/06; C09K 19/34

(52) U.S. Cl. 252/299.61; 252/299.6

(57) ABSTRACT

A liquid crystal mixture includes 30 to 90 parts by weight of a first composition including at least one compound having the following formula (A)

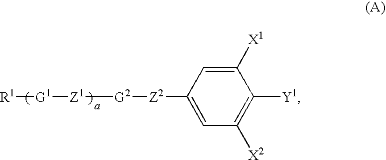

5 to 45 parts by weight of a second composition including at least one perfluoroallyloxy compound having the following formula (B)

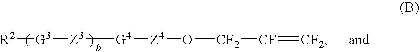

1 to 20 parts by weight of a third composition including at least one compound having the following formula (C)

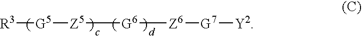

### BACKGROUND OF THE INVENTION

1. Field of the Invention

This invention relates to a liquid crystal mixture, more particularly to a liquid crystal mixture used in manufacturing a liquid crystal display having a small or medium size.

2. Description of the Related Art

Because of its characteristics including thin size, lightweight, low power consumption, and no radiation, a liquid crystal display has been widely employed in several products, e.g., a mobile phone, a digital camera, a radiophone, a monitor, etc. Because some of the products, e.g., mobile phone, digital camera, etc., are usually used in a car or outdoors for a long period of time, the products are unavoidably exposed to undesired high and low temperatures. Therefore, how to raise a clearing point (Tₙᵢ) or to lower a crystallizing point of a liquid crystal composition/mixture has always been sought in this field.

U.S. Pat. No 7,001,647 discloses a perfluoroallyloxy compound represented by the following formula.

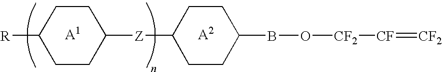

In the formula, P represents R′, R′O, R′OCO, or R′COO; R′ represents an alkyl group which may have an unsaturated bond, a —CH₂— moiety of the alkyl group may be displaced with —O—, —CO—, or —COO—, and a part or all of the hydrogen atoms of the alkyl group may be substituted with a halogen atom or a cyano group; A¹ and A² each represent 1,4-phenylene (a —CH═ moiety of which may be displaced with —N═, and a part or all of the hydrogen atoms of which may be substituted with a halogen atom or a cyano group), 1,4-cyclohexylene (a —CH₂— moiety of which may be displaced with —O— or —S—, a part or all of the hydrogen atoms of which may be substituted with a halogen atom or a cyano group), 2,6-naphthylene, or 2,6-decahydronaphthylene; Z represents a single bond, —COO—, —OCO—, —CH₂CH₂—, —CH═CH—, —(CH₂)₄—, —CH₂O—, —OCH₂—, —(CH₂)₃O—, —O(CH₂)₃—, —CH═CHCH₂O—, —OCH₂CH═CH—, —C≡C—, —CF₂O—, or —OCF₂—; B represents a single bond or an alkylene group, a part or all of the hydrogen atoms of the alkylene group may be substituted with a halogen atom or a cyano group; and n represents 1, 2, or 3; when n is 2 or 3, A¹ and Z may each be the same or different. The perfluoroallyloxy compound can be mixed with a nematic liquid crystal material to provide a liquid crystal composition having a low viscosity (γ₁), a low refractive index anisotropy (Δn), a high dielectric anisotropy (Δε) and a broad temperature range for a nematic phase.

In one PCT patent application, i.e., WO 2006/061966, there is disclosed a liquid crystal composition containing 15% by mass or more of a compound having a terminal structure represented by the following formula.

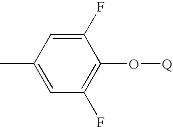

In the aforesaid formula, Q represents a saturated or unsaturated alkyl group having 1-8 carbon atoms which may be substituted by a halogen atom. The liquid crystal composition exhibits high Δε and low γ₁, and is thus suitable for use as a liquid crystal composition for in-plane switching liquid crystal displays or low voltage-driven TN liquid crystal displays.

In another PCT patent application, i.e., WO 2006/132015, there is disclosed a specific compound having the following structure:

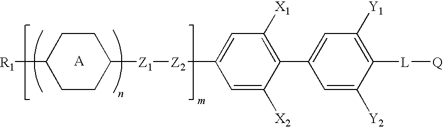

In the formula, R₁ is H or C₁₋₈ alkyl; ring A is 1,4-phenylene, 1,4-trans-cyclohexylene, or 2,6-naphthylene; Z₁ and Z₂ each are a single bond, —COO—, —OCO—, —CH₂CH₂—, —CH═CH—, —CH₂O—, —OCH₂—, or —C≡C—; m is 1 or 2; n is 0 or 1; X₁ and X₂ each are C₁₋₃ alkyl, alkoxy or H, provided that when one of X₁ and X₂ is H, the other is not H; Y₁ and Y₂ each are H, F, or Cl; Q is C₁₋₈ (un)saturated alkyl in which all or part of the hydrogen atoms are replaced with a halogen atom; and L is oxygen or a single bond.

Although the compounds disclosed in the aforesaid patent or patent applications exhibit good physical properties, when mixed with other liquid crystal compounds to meet industrial requirements certain physical properties thereof will be adversely affected, e.g., the temperature range for a nematic phase is likely to diminish.

Therefore, there is a need in the art to provide a liquid crystal mixture that can provide, e.g., a wider temperature range for a nematic phase.

### SUMMARY OF THE INVENTION

According to this invention, a liquid crystal mixture includes 30 to 90 parts by weight of a first composition, 5 to 45 parts by weight of a second composition, and 1 to 20 parts by weight of a third composition. The first composition includes at least one compound having the following formula (A):

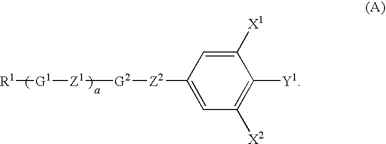

The second composition includes at least one perfluoroallyloxy compound having the following formula (B):

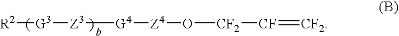

The third composition includes at least one compound having the following formula (C):

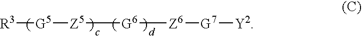

G¹, G², G³, G⁴, G⁵, and G⁶ independently represent 1,4-phenylene, 1,4-cyclohexylene, 2,6-naphthylene, or 2,6-decahydronaphthylene, a —CH═ moiety of the 1,4-phenylene being optionally substituted with —N═, each of hydrogen atoms of the 1,4-phenylene being optionally substituted with a halogen atom or a cyano group, a —CH₂— moiety of the 1,4-cyclohexylene being optionally substituted with —O—, —N—, or —S—, each of hydrogen atoms of the 1,4-cyclohexylene being optionally substituted with a halogen atom or a cyano group. G⁷ represents 1,4-phenylene, 3-fluoro-1,4-phenylene, 5-fluoro-1,4-phenylene, 1,4-cyclohexylene, 2,6-naphthylene, or 2,6-decahydronaphthylene. Z¹, Z², Z³, Z⁵, and Z⁶ independently represent a single bond, —COO—, —OCO—, —CH₂CH₂—, —CH═CH—, —(CH₂)₄—, —CH₂O—, —OCH₂—, —(CH₂)₃O—, —O(CH₂)₃—, —CH═CHCH₂O—, —OCH₂CH═CH—, —C≡C—, —CF₂O—, or —OCF₂—. Z⁴ represents a single bond or an alkylene group, each of hydrogen atoms of the alkylene group being optionally substituted with a halogen atom or a cyano group. R¹, R², and R³ independently represent R, RO, ROCO, or RCOO, R being an alkyl group which optionally has at least one double bond, a —CH₂— moiety of the alkyl group being optionally substituted with —O—, —CO—, or —COO—, and each of hydrogen atoms of the alkyl group being optionally substituted with a halogen atom or a cyano group. X¹, X², and Y¹ independently represent a hydrogen atom, a halogen atom, —CF₃—, —OCF₃—, —OCF₂H—, or —OCFH₂—, with the proviso that, when X¹ and X² are hydrogen, Y¹ cannot be a hydrogen atom, a halogen atom, or —OCFH₂—. Y² represents F, Cl, —OCFH₂, a linear or branched C₁-C₇ alkyl group, alkoxy group, or a C₂-C₇ alkenyl group, with the proviso that, when G⁷ is 3-fluoro-1,4-phenylene, Y cannot be F, Cl, or —OCFH₂. a is 0, 1 or 2. When a is 2, in each occurrence, G¹ and Z¹ are independently the same or different. b is 1, 2, or 3. When b is 2 or 3, in each occurrence, G³ and Z³ are independently the same or different. c and d are independently 0, 1, or 2, and c+d>0. When c is 2, in each occurrence, G⁵ and Z⁵ are independently the same or different.

### DETAILED DESCRIPTION OF THE PREFERRED EMBODIMENTS

A liquid crystal mixture according to this invention is obtained by mixing 30 to 90 parts by weight of a first composition, 5 to 45 parts by weight of a second composition, and 1 to 20 parts by weight of a third composition. The first composition includes at least one compound having the following formula (A)

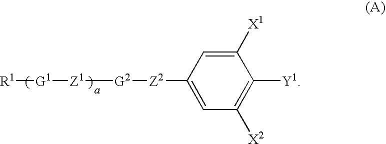

The second composition includes at least one perfluoroallyloxy compound having the following formula (B)

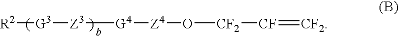

The third composition includes at least one compound having the following formula (C)

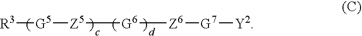

In compounds (A), (B), and (C), G¹, G², G³, G⁴, G⁵, and G⁶ independently represent 1,4-phenylene, 1,4-cyclohexylene, 2,6-naphthylene, or 2,6-decahydronaphthylene. When G¹, G², G³, G⁴, G⁵, and G⁶ are independently 1,4-phenylene, a —CH═ moiety of 1,4-phenylene is optionally substituted with —N═, and each of hydrogen atoms of the 1,4-phenylene is optionally substituted with a halogen atom or a cyano group. When G¹, G², G³, G⁴, G⁵, and G⁶ are independently 1,4-cyclohexylene, a —CH₂— moiety of the 1,4-cyclohexylene is optionally substituted with —O—, —N—, or —S—, and each of hydrogen atoms of the 1,4-cyclohexylene is optionally substituted with a halogen atom or a cyano group.

G⁷ represents 1,4-phenylene, 3-fluoro-1,4-phenylene, 5-fluoro-1,4-phenylene, 1,4-cyclohexylene, 2,6-naphthylene, or 2,6-decahydronaphthylene.

Z¹, Z², Z³, Z⁵, and Z⁶ independently represent a single bond, —COO—, —OCO—, —CH₂CH₂—, —CH═CH—, —(CH₂)₄—, —CH₂O—, —OCH₂—, —(CH₂)₃O—, —O(CH₂)₃—, —CH═CHCH₂O—, —OCH₂CH═CH—, —C≡C—, —CF₂O—, or —OCF₂—.

Z⁴ represents a single bond or an alkylene group, and each of hydrogen atoms of the alkylene group is optionally substituted with a halogen atom or a cyano group.

R¹, R², and R³ independently represent R, RO, ROCO, or RCOO. R is an alkyl group which optionally has at least one double bond, a —CH₂— moiety of the alkyl group being optionally substituted with —O—, —CO—, or —COO—, and each of hydrogen atoms of the alkyl group being optionally substituted with a halogen atom or a cyano group.

X¹, X², and Y¹ independently represent a hydrogen atom, a halogen atom, —CF₃—, —OCF₃—, —OCF₂H—, or —OCFH₂—. When X¹ and X² are hydrogen, Y¹ cannot be hydrogen, halogen, or —OCFH₂—.

Y² represents F, Cl, —OCFH₂, a linear or branched C₁-C₇ alkyl group, an alkoxy group, or a C₂-C₇ alkenyl group. When G⁷ is 3-fluoro-1,4-phenylene, Y cannot be F, Cl, or —OCFH₂.

a is 0, 1 or 2, and b is 1, 2, or 3. When a is 2, in each occurrence, G¹ and Z¹ are independently the same or different. When b is 2 or 3, in each occurrence, G³ and Z³ are independently the same or different.

c and d are independently 0, 1, or 2, and c+d>0. When c is 2, in each occurrence, G⁵ and Z⁵ are independently the same or different.

Preferably, the first composition is present in an amount ranging from 65 to 85 parts by weight, the second composition is present in an amount ranging from 9 to 27 parts by weight, and the third composition is present in an amount ranging from 3 to 14 parts by weight. More preferably, the first composition is present in an amount ranging from 69 to 84 parts by weight, the second composition is present in an amount ranging from 12 to 27 parts by weight, and the third composition is present in an amount ranging from 4 to 6 parts by weight. Most preferably, the first composition is present in an amount ranging from 68 to 71 parts by weight, the second composition is present in an amount ranging from 24 to 27 parts by weight, and the third composition is present in an amount ranging from 4.5 to 5.5 parts by weight.

In the liquid crystal mixture of this invention, the first composition provides high Δε property; the second composition provides the following properties, i.e., low γ₁, relatively high Δε, high Tₙᵢ, high impedance, and superior stability at low temperature; and the third composition provides low γ₁ and high Tₙᵢ. It should be noted that the first composition should be present in an amount greater than 30 parts by weight so as to render the liquid crystal mixture to exhibit a relatively high Δε. However, when the third composition is present in an amount greater than 20 parts by weight, Δε property of the liquid crystal mixture will be decreased. Therefore, the first, second, and third compositions in the liquid crystal mixture should be maintained at the specific weight ratio so as to obtain the desired physical properties.

Preferably, in the compound (A) G¹ and G² independently represent 1,4-phenylene, 1,4-cyclohexylene, 3-fluoro-1,4-phenylene, 5-fluoro-1,4-phenylene, 3,5-difluoro-1,4-phenylene, or piperazinyl. Z¹ and Z² independently represent a single bond, —COO—, —OCO—, —CH₂CH₂—, —CH═CH—, —CH₂O—, —OCH₂—, —CF₂O—, or —OCF₂—. R¹ represents R or RO. R is a linear or branched C₁-C₇ alkyl group, or a linear or branched C₂-C₇ alkyl group having an unsaturated bond.

Preferably, examples of the compound (A) include:

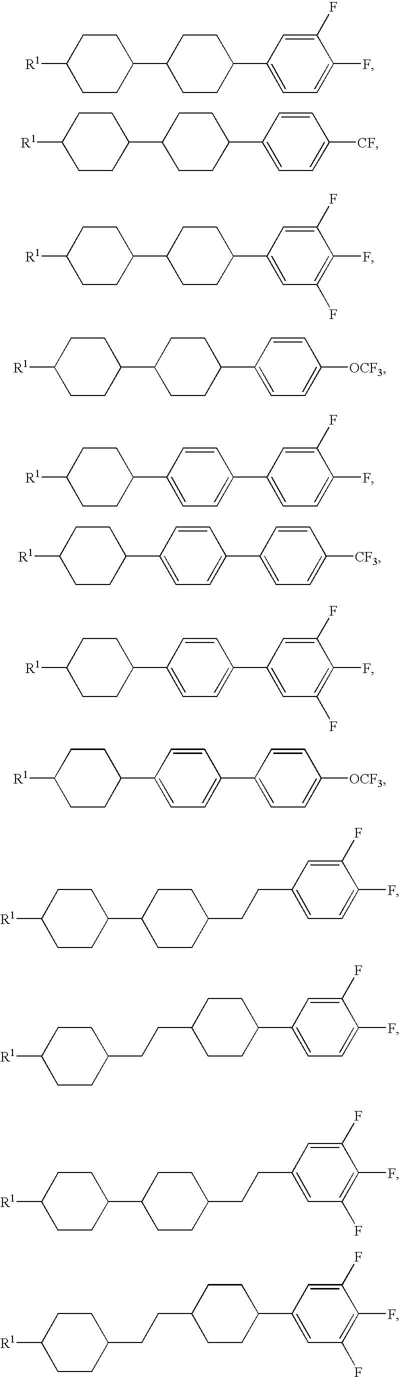

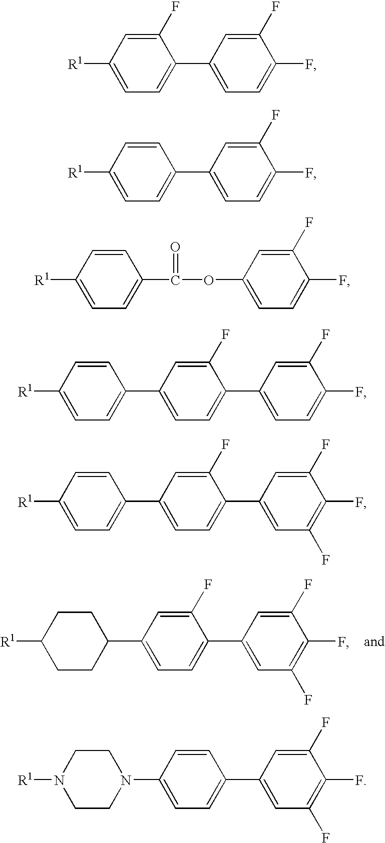

More preferably, examples of the compound (A) include:

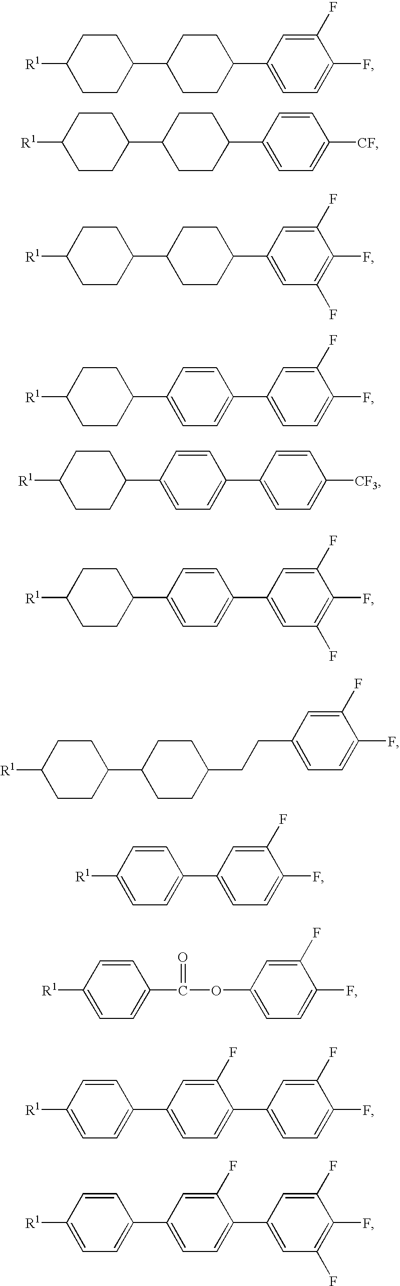

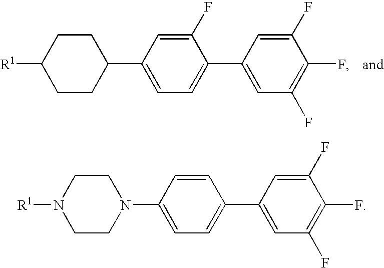

The specific examples of the compound (A) used in the embodiments of this invention are as follows:

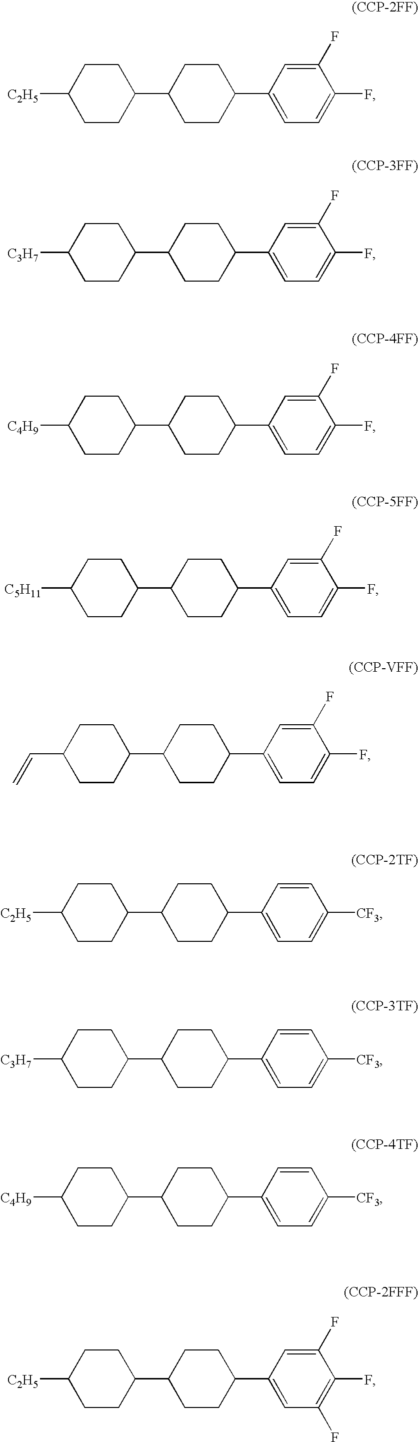

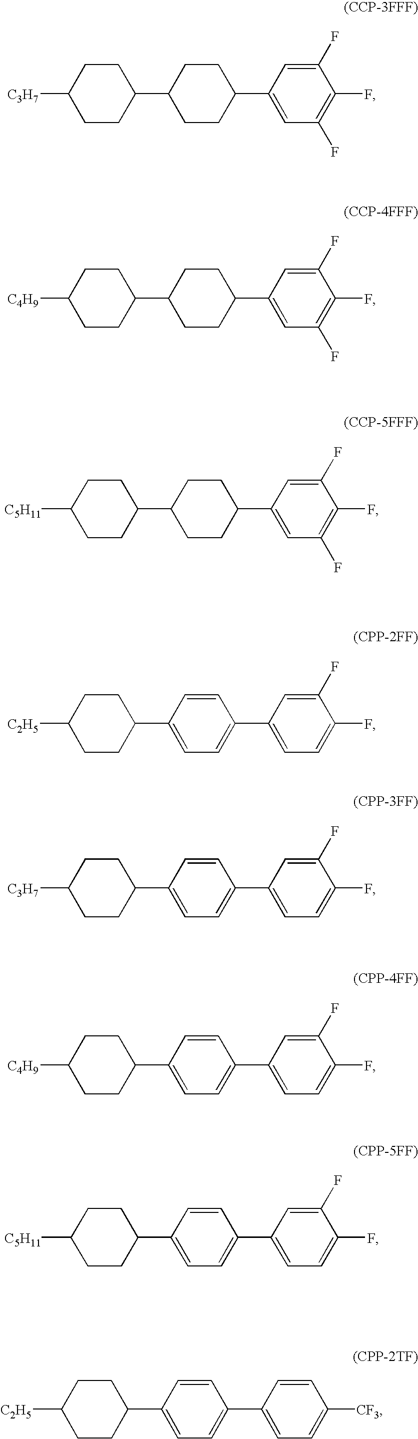

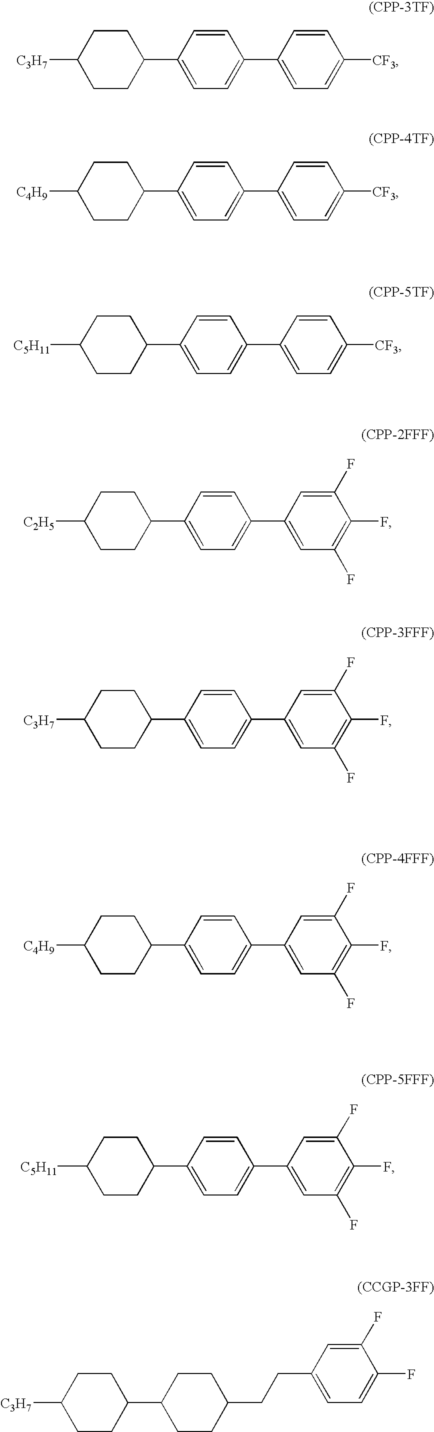

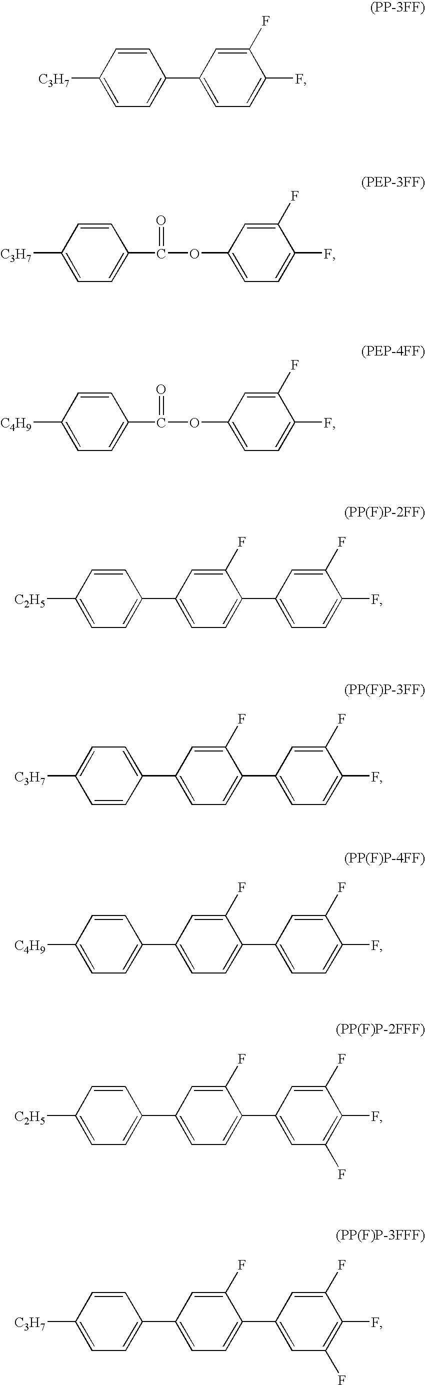

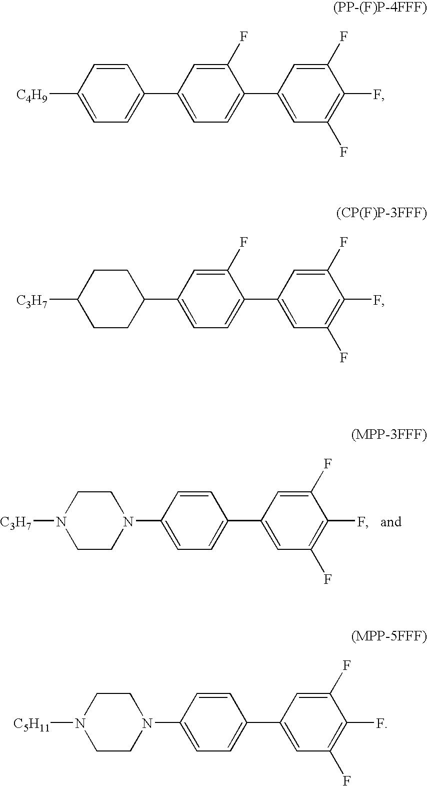

It should be noted that each compound is abbreviated, e.g., CCP-3FF indicates two cyclohexylene groups, one phenylene group, 3 carbons for R¹, and two fluorine atoms.

Preferably, in the compound (B) G³ and G⁴ independently represent 1,4-phenylene, 1,4-cyclohexylene, 3-fluoro-1,4-phenylene, 5-fluoro-1,4-phenylene, or 3,5-difluoro-1,4-phenylene. Z⁴ is a single bond. R² represents R or RO. R is a linear or branched C₁-C₇ alkyl group, or a linear or branched C₂-C₇ alkyl group having an unsaturated bond.

Examples of the perfluoroallyloxy compound (B) include:

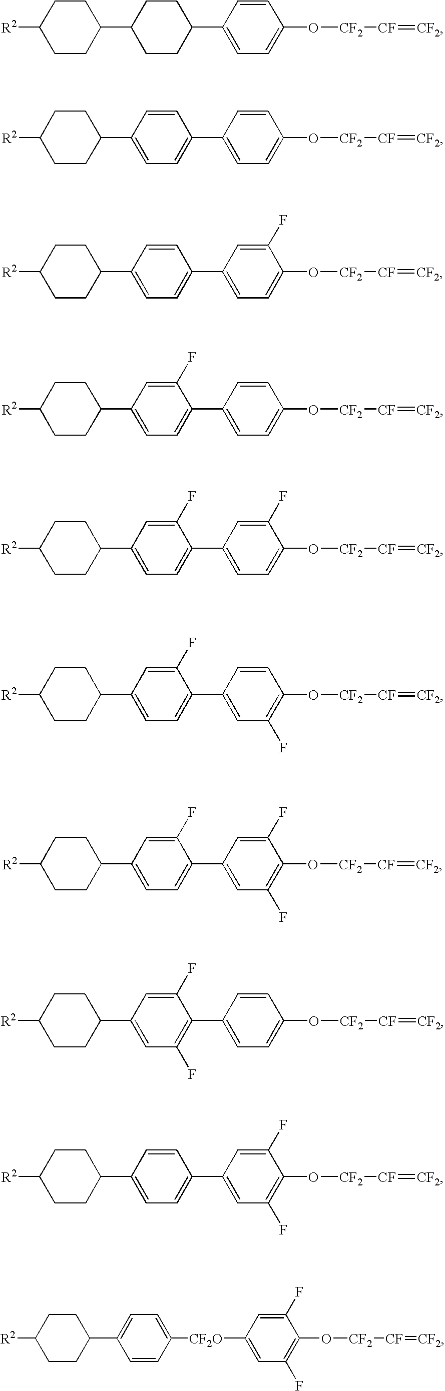

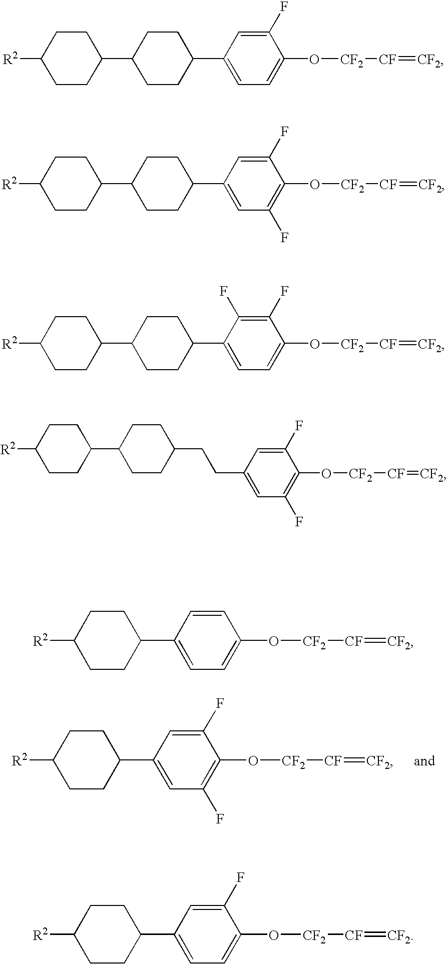

More preferably, examples of the compound (B) include:

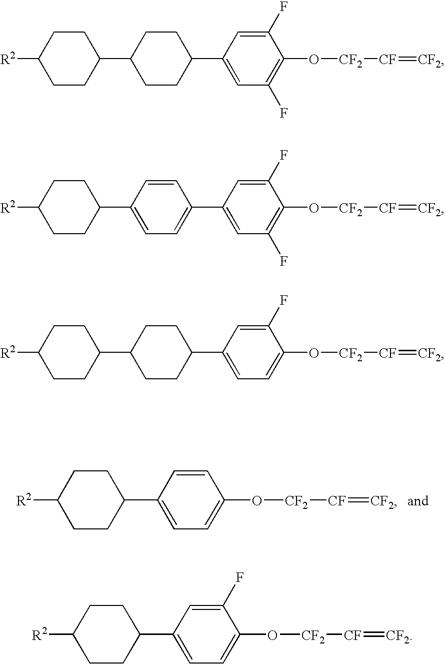

The specific examples of the perfluoroallyloxy compound (B) used in the embodiments of this invention and the abbreviations thereof are as follows:

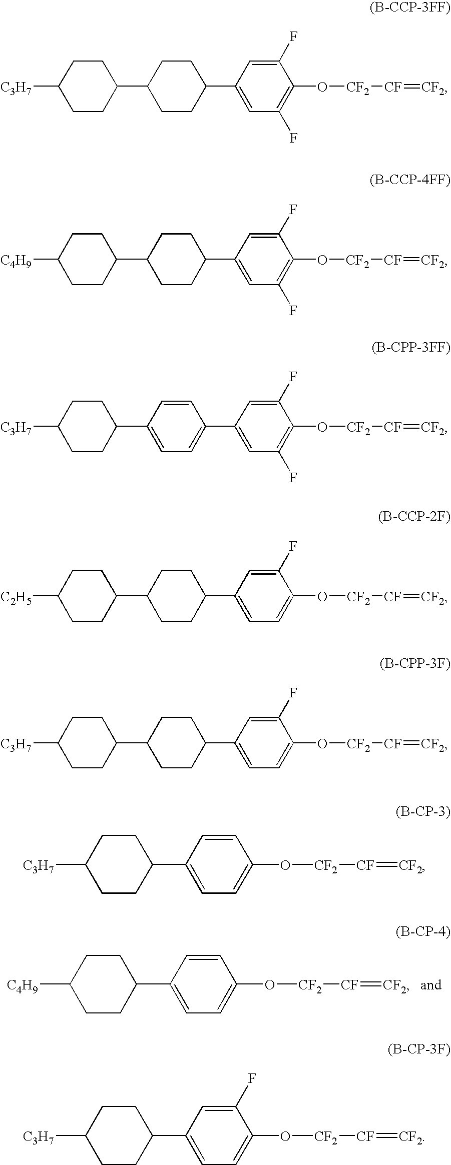

Preferably, in the compound (C) G⁵ and G⁶ independently represent 1,4-phenylene, 1,4-cyclohexylene, 3-fluoro-1,4-phenylene, 5-fluoro-1,4-phenylene, or 3,5-difluoro-1,4-phenylene. G⁷ represents 1,4-phenylene or 1,4-cyclohexylene. R³ represents R or RO, and R is a linear or branched C₁-C₇ alkyl group, or a linear or branched C₂-C₇ alkyl group having an unsaturated bond.

Preferably, examples of the compound (C) include:

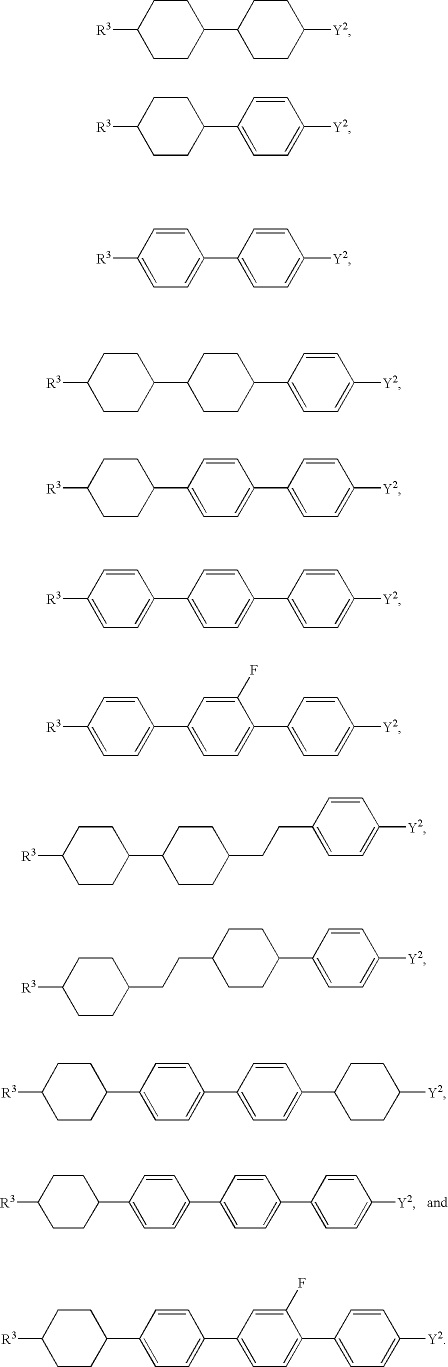

More preferably, examples of the compound (C) include:

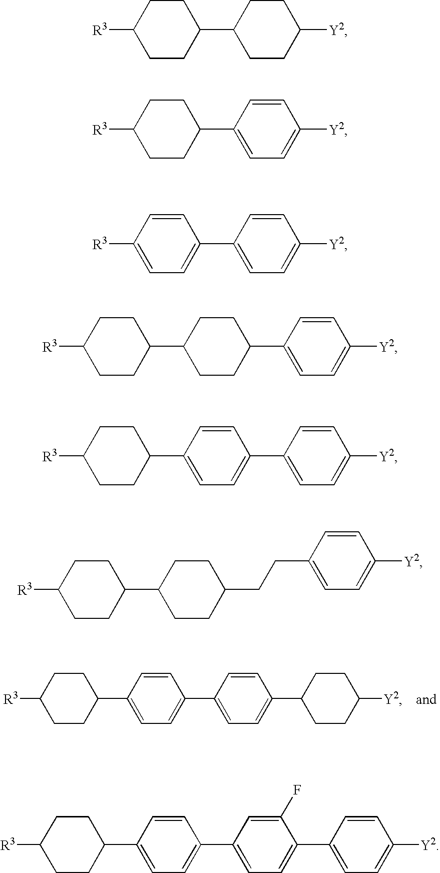

The specific examples of the compound (C) used in the embodiments of this invention and the abbreviations thereof are as follows:

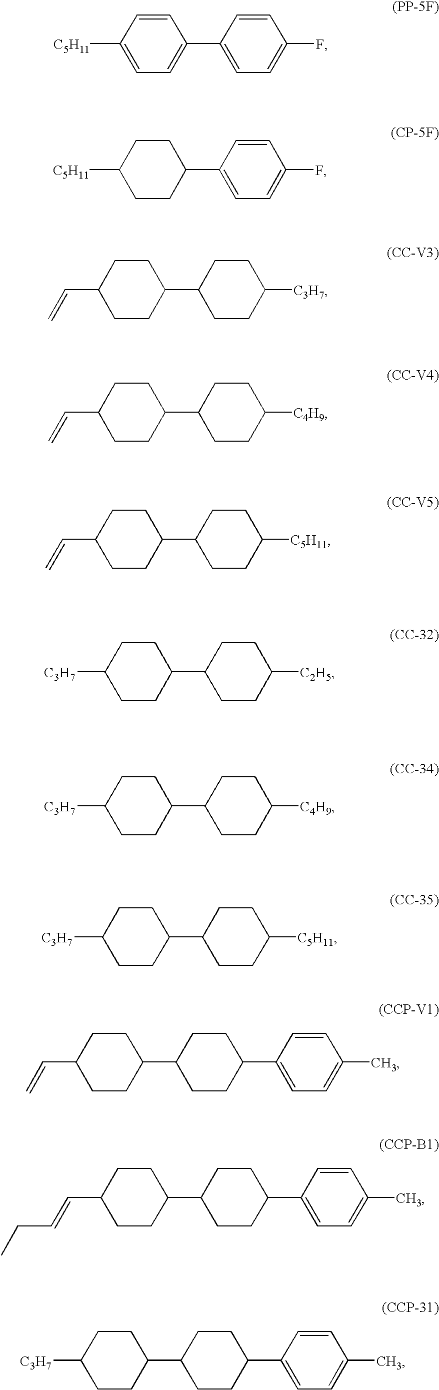

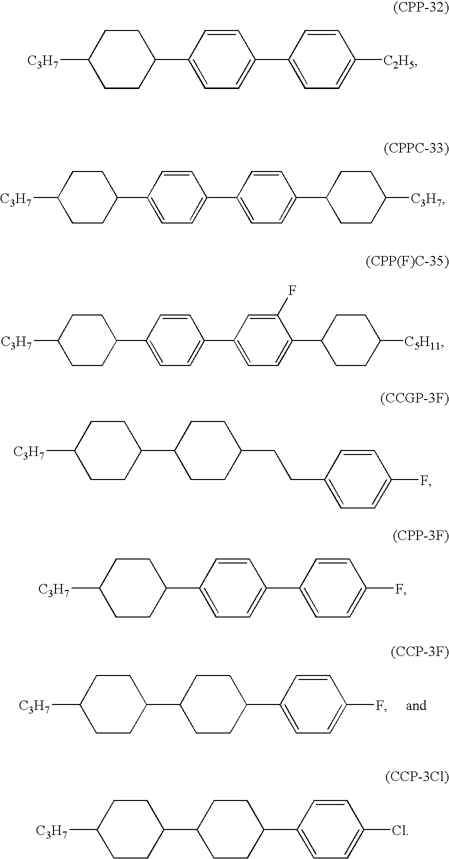

### EXAMPLE

### Preparation of Liquid Crystal Mixtures of Examples 1-10 and Comparative Examples 1-3

The liquid crystal mixtures of Examples 1-10 and Comparative Examples 1-3 were prepared by mixing the first, second, and third compositions, respectively. The compounds (A), (B), and (C) included in the first, second, and third compositions, respectively, and the parts by weight thereof are Listed in Table -1.

TABLE 1

| | Composition (A) | Composition (B) | Composition (C) |
|---|---|---|---|
| Example 1 | CCP-2FF(17.0) | B-CCP-3FF(8.4) | CCP-3Cl(2.0) |
| (A_{89.6}B_{8.4}C_{2.0}) | CCP-3FF(12.0) | | |
| | CCP-4FF(16.0) | | |
| | CCP-5FF(10.8) | | |
| | CPP-2FF(7.0) | | |
| | CPP-4FF(7.4) | | |
| | CCP-4TF(4.0) | | |
| | CPP-2TF(3.4) | | |
| | CPP-3TF(3.0) | | |
| | CPP-5TF(2.0) | | |
| | PP-3FF(7.0) | | |
| Example 2 | CCP-2FFF(6.0) | B-CCP-3FF(12.0) | CC-V3(4.0) |
| (A_{84.0}B_{12.0}C_{4.0}) | CCP-3FFF(6.0) | | |
| | CCP-2FF(13.0) | | |
| | CCP-3FF(13.0) | | |
| | CCP-4FF(12.0) | | |
| | CCP-4FF(13.5) | | |
| | CPP-3FFF(7.0) | | |
| | CPP-2TF(3.0) | | |
| | CPP-3TF(2.5) | | |
| | CCGP-3FF(4.0) | | |
| | PP(3F)P-3FF(4.0) | | |
| Example 3 | CCP-2FF(11.0) | B-CCP-3FF(14.5) | CCP-31(1.5) |
| (A_{82.5}B_{14.5}C_{3.0}) | CCP-3FF(13.8) | | CPPC-33(1.5) |
| | CCP-4FF(12.0) | | |
| | CCP-5FF(14.8) | | |
| | CPP-3FF(10.1) | | |
| | CPP-4FF(6.0) | | |
| | CCP-4TF(3.0) | | |
| | CPP-2TF(3.8) | | |
| | CPP-3TF(2.8) | | |
| | PP-3FF(5.2) | | |
| Example 4 | CCP-2FFF(6.0) | B-CCP-3FF(6.0) | CC-V3(4.0) |
| (A_{78.0}B_{18.0}C_{4.0}) | CCP-3FFF(6.0) | B-CCP-4FF(6.0) | |
| | CCP-2FF(13.0) | B-CPP-3FF(6.0) | |
| | CCP-3FF(12.0) | | |
| | CCP-4FF(12.0) | | |
| | CCP-4FF(13.0) | | |
| | CPP-3FFF(7.0) | | |
| | CPP-2TF(3.0) | | |
| | CPP-3TF(2.0) | | |
| | PP(3F)P-3FFF(4.0) | | |
| Example 5 | CCP-3FFF(10.0) | B-CCP-3FF(9.8) | CC-V5(8.0) |
| (A_{77.2}B_{9.8}C_{13.0}) | CCP-4FFF(10.0) | | CCP-V1(5.0) |
| | CCP-2FF(4.0) | | |
| | CCP-3FF(10.0) | | |
| | CCP-5FF(11.2) | | |
| | CPP-3FF(8.0) | | |
| | CPP-2TF(3.8) | | |
| | CPP-3TF(3.2) | | |
| | CPP-3FFF(7.0) | | |
| | CCGP-3FF(10.0) | | |
| Example 6 | CCP-2FF(9.5) | B-CCP-3FF(15.2) | CCP-V1(4.8) |
| (A_{70.5}B_{24.7}C_{4.8}) | CCP-3FF(11.4) | B-CPP-3FF(9.5) | |
| | CCP-4FF(9.5) | | |
| | CCP-5FF(9.5) | | |
| | CPP-2FF(5.7) | | |
| | CCP-2TF(3.8) | | |
| | CCP-5TF(2.9) | | |
| | CPP-3TF(2.9) | | |
| | CPP-5TF(2.0) | | |
| | PP-3FF(13.3) | | |
| Example 7 | CCP-2FF(10.0) | B-CCP-3FF(16.0) | CCP-V1(5.0) |
| (A_{69.0}B_{26.0}C_{5.0}) | CCP-3FF(12.0) | B-CPP-3FF(10.0) | |
| | CCP-4FF(10.0) | | |
| | CCP-5FF(10.0) | | |
| | CPP-2FF(6.0) | | |
| | CCP-2TF(4.0) | | |
| | CCP-5TF(3.0) | | |
| | CPP-3TF(3.0) | | |
| | CPP-5TF(2.0) | | |
| | PP-3FF(9.0) | | |
| Example 8 | CCP-2FF(10.6) | B-CCP-3FF(14.5) | CPP-3F(10.1) |
| (A_{66.1}B_{20.5}C_{13.4}) | CCP-3FF(13.8) | B-CPP-3FF(6.0) | CPP-31(2.3) |
| | CCP-4FF(12.0) | | CPP-32(1.0) |
| | CCP-5FF(14.8) | | |
| | CCP-4TF(3.3) | | |
| | CPP-2TF(3.8) | | |
| | CPP-3TF(2.8) | | |
| | PP-3FF(5.0) | | |
| Example 9 | CCP-2FFF(10.0) | B-CCP-3FF(8.0) | CC-V5(11.0) |
| (A_{55.0}B_{26.0}C_{19.0}) | CCP-3FFF(10.0) | B-CCP-4FF(10.0) | CCP-2D1(3.0) |
| | CCP-4FFF(10.0) | B-CPP-3FF(8.0) | CPPC-33(2.0) |
| | CCP-3FF(6.0) | | CPP-2F(3.0) |
| | CCP-4TF(3.0) | | |
| | CPP-3FFF(8.0) | | |
| | CPP-5FFF(5.0) | | |
| | CPP-3TF(3.0) | | |
| Example 10 | CCP-2FFF(8.0) | B-CCP-3FF(10.0) | CCGP-3F(7.0) |
| (A_{48.0}B_{45.0}C_{7.0}) | CCP-3FFF(10.0) | B-CPP-3FF(10.0) | |
| | CPP-4FFF(10.0) | B-CCP-4FF(8.0) | |
| | CPP-3FFF(5.0) | B-CCP-3F(10.0) | |
| | CPP-3FF(9.0) | B-CP-3F(7.0) | |
| | CCP-3TF(3.0) | | |
| | CPP-3TF(3.0) | | |
| Comparative | PP(3F)P-3FF(5.0) | B-CCP-3FF(12.0) | CC-V3(10.0) |
| Example 1 | | B-CPP-3FF(11.0) | CCGP-3F(10.0) |
| (A_{5.0}B_{70.0}C_{25.0}) | | B-CCP-4FF(12.0) | CPP-5F(5.0) |
| | | B-CCP-2F(7.0) | |
| | | B-CCP-3F(7.0) | |
| | | B-CP-3(6.0) | |
| | | B-CP-4(6.0) | |
| | | B-CP-3F(9.0) | |
| Comparative | PP-3FF(5.0) | B-CCP-3FF(12.0) | CC-V3(11.0) |
| Example 2 | CCP-2FFF(4.0) | B-CPP-3FF(12.0) | CCGP-3F(10.0) |
| (A_{20.0}B_{50.0}C_{30.0}) | CCP-3FFF(6.0) | B-CCP-4FF(12.0) | CPP-2F(5.0) |
| | CCP-4FFF(5.0) | B-CCP-3F(7.0) | CCP-V1(4.0) |
| | | B-CP-3F(7.0) | |
| Comparative | PP(3F)P-3FF(5.0) | B-CCP-3FF(12.0) | CCGP-3F(5.0) |
| Example 3 | CCP-5FF(7.0) | B-CPP-3FF(11.0) | |
| (A_{35.0}B_{60.0}C_{5.0}) | CCP-3TF(3.0) | B-CCP-4FF(12.0) | |
| | CCP-3FFF(10.0) | B-CCP-2F(6.0) | |
| | CCP-4FFF(10.0) | B-CP-3(6.0) | |
| | | B-CP-4(7.0) | |
| | | B-CP-3F(6.0) | |

### Test Methods

The liquid crystal mixtures of this invention and the comparative examples were tested for measuring the following properties. The results are shown in Table 2.
(1) Clearing point (Tₙᵢ, ° C.), the temperature at which the liquid crystal mixture is transformed from liquid crystal phase to liquid phase, was measured by heating the liquid crystal mixture using a heater and observing the phase change using a microscope.
(2) Refractive index anisotropy (Δn) was measured using Abbe refractometer at 589.3 nm. According to the requirement for small or medium liquid crystal displays, Δn preferably ranges from 0.07 to 0.10.
(3) Dielectric anisotropy (Δε), a difference between the average dielectric constant measured parallel to the long axis of a molecule and the average dielectric constant measured perpendicular to the long axis of the molecule, was measured using LT-938 available from AMT company, Japan, at 25° C. after the liquid crystal mixture was injected into a homogenous alignment cell and a homeotropic alignment cell. According to the requirement for small or medium liquid crystal displays, Δε preferably ranges from 5 to 12.
(4) Threshold voltage (Vₜₕ) was measured by injecting each of the liquid crystal mixtures to be tested into a cell having a 4 μm wall thickness, and applying a voltage (5V, 64 Hz) to the cell filled with the liquid crystal mixture using DMS-501 available from Autronic company, Germany, so as to obtain a transmission-voltage curve. Vₜₕ for each of the liquid crystal mixtures was calculated from the curve using a computer. Vₜₕ used in the industry ranges from 1.2 to 1.6 V.
(5) Response time (RT) was measured by injecting each of the liquid crystal mixtures to be tested into a cell having a 4 μm wall thickness, and applying a voltage (4V, 64 Hz) to the cell filled with the liquid crystal mixture using DMS-501 available from Autronic company, Germany. RT for each of the liquid crystal mixtures was calculated using a computer. RT was expected to be smaller than 30 msec at 4V.
(6) The lowest storage temperature was determined by depositing 1 to 2 g of each of the liquid crystal mixtures in a 7 ml transparent glass in a freezer at 0 to −40° C. for 240 hours. The lowest storage temperature was one at which no crystal was observed and the mixture still possesses flowability.

TABLE 2

| | | | | | | Lowest | |
|---|---|---|---|---|---|---|---|
| | | | | | | storage | |
| | | | Vₜₕ | RT | Tₙᵢ | temp. | ΔT (Tₙᵢ − |
| | Δn | Δε | (V) | (msec) | (° C.) | (T_{L}, ° C.) | T_{L}) |
| Exp. 1 | 0.0975 | 8.56 | 1.369 | 24.0 | 90.6 | −20 | 110.6 |
| Exp. 2 | 0.0937 | 9.15 | 1.389 | 22.0 | 101.4 | −20 | 121.4 |
| Exp. 3 | 0.1010 | 8.58 | 1.535 | 19.7 | 104.9 | −10 | 114.9 |
| Exp. 4 | 0.0959 | 9.68 | 1.294 | 22.2 | 100.7 | −20 | 120.7 |
| Exp. 5 | 0.0950 | 8.69 | 1.476 | 20.8 | 103.2 | −10 | 113.2 |
| Exp. 6 | 0.0982 | 8.29 | 1.419 | 18.3 | 85.3 | −40 | 125.3 |
| Exp. 7 | 0.1000 | 8.80 | 1.46 | 18.1 | 96.5 | −40 | 136.5 |
| Exp. 8 | 0.1020 | 8.68 | 1.53 | 19.7 | 105.5 | −10 | 115.5 |
| Exp. 9 | 0.0987 | 9.51 | 1.349 | 20.3 | 100.8 | −10 | 110.8 |
| Exp. 10 | 0.0961 | 10.25 | 1.431 | 21.5 | 108.3 | −10 | 118.3 |
| Comp. | 0.0976 | 6.19 | 1.761 | 17.2 | 92.6 | −10 | 102.6 |
| Exp. 1 | | | | | | | |
| Comp. | 0.0931 | 7.1 | 1.591 | 18.9 | 95.2 | −10 | 105.2 |
| Exp. 2 | | | | | | | |
| Comp. | 0.0956 | 8.82 | 1.491 | 21.5 | 95.4 | −10 | 105.4 |
| Exp. 3 | | | | | | | |

It can be noted, from Table 2, that the liquid crystal mixtures according to this invention have a relatively broad ΔT. To be specific, compared to the comparative examples, the liquid crystal mixtures in most of the examples of this invention exhibit a higher Tₙᵢ. Even though the liquid crystal mixtures in some of the examples of this invention have the Tₙᵢ similar to or lower than that of the comparative examples, T_{L} thereof is lower than that of the comparative examples. Therefore, compared to the comparative examples, the liquid crystal mixtures provide a broader temperature for a nematic phase for a liquid crystal device. In addition, Δn, Δε, Vₜₕ, and RT of the examples of this invention meet the requirements for the liquid crystal device in the industry.

According to the present invention, with the inclusion of 30 to 90 parts by weight of the first composition, 5 to 45 parts by weight of the second composition, and 1 to 20 parts by weight of the third composition, the liquid crystal mixture of this invention provides a relatively broad temperature range for a nematic phase.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A liquid crystal mixture, comprising:
30 to 90 parts by weight of a first composition including at least one compound having the following formula (A) 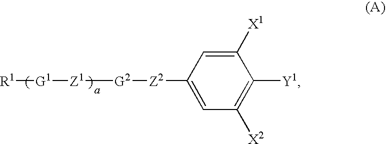
5 to 45 parts by weight of a second composition including at least one perfluoroallyloxy compound having the following formula (B) 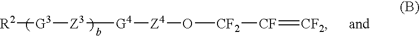
1 to 20 parts by weight of a third composition including at least one compound having the following formula (C) 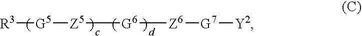
wherein G¹, G², G⁴, G⁵, and G⁶ independently represent 1,4-phenylene, 1,4-cyclohexylene, 2,6-naphthylene, or 2,6-decahydronaphthylene, a —CH═ moiety of the 1,4-phenylene being optionally substituted with —N═, each of hydrogen atoms of the 1,4-phenylene being optionally substituted with a halogen atom or a cyano group, a —CH₂— moiety of the 1,4-cyclohexylene being optionally substituted with —O—, —N—, or —S—, each of hydrogen atoms of the 1,4-cyclohexylene being optionally substituted with a halogen atom or a cyano group;
G⁷represents 1,4-phenylene, 3-fluoro-1,4-phenylene, 5-fluoro-1,4-phenylene, 1,4-cyclohexylene, 2,6-naphthylene, or 2,6-decahydronaphthylene;
Z¹, Z², Z³, Z⁵, and Z⁶ independently represent a single bond, —COO—, —OCO—, —CH₂CH₂—, —CH═CH—, —(CH₂)₄—, —CH₂O—, —OCH₂—, —(CH₂)₃O—, —O(CH₂)₃—, —CH═CHCH₂O—, —OCH₂C═CH—, —C≡C—, —CF₂O—, or —OCF₂—;
Z⁴ represents a single bond or an alkylene group, each of hydrogen atoms of the alkylene group being optionally substituted with a halogen atom or a cyano group;
R¹, R², and R³ independently represent R, RO, ROCO, or RCOO, R being an alkyl group which optionally has at least one double bond, a —CH₂— moiety of the alkyl group being optionally substituted with —O—, —CO—, or —COO—, and each of hydrogen atoms of the alkyl group being optionally substituted with a halogen atom or a cyano group;
X¹, X², and Y¹ independently represent a hydrogen atom, a halogen atom, —CF₃—, —OCF₃—, —OCF₂H—, or —OCFH₂—, with the proviso that, when X¹ and X² are hydrogen, Y¹ cannot be a hydrogen atom, a halogen atom, or —OCFH₂—;
Y² represents F, Cl, —OCFH₂, a linear or branched C₁-C₇ alkyl group, an alkoxy group, or a C₂-C₇ alkenyl group, with the proviso that, when G⁷ is 3-fluoro-1,4-phenylene, Y cannot be F, Cl, or —OCFH₂;
a is 0, 1 or 2, in which, when a is 2, in each occurrence, G¹ and Z¹ are independently the same or different;
b is 1, 2, or 3, in which, when b is 2 or 3, in each occurrence, G³ and Z³ are independently the same or different; and
c and d are independently 0, 1, or 2, and c+d>0, in which, when c is 2, in each occurrence, G⁵ and Z⁵ are independently the same or different.

2. The liquid crystal mixture of claim 1, wherein said first composition is present in an amount ranging from 65 to 85 parts by weight, said second composition being present in an amount ranging from 9 to 27 parts by weight, said third composition being present in an amount ranging from 3 to 14 parts by weight.

3. The liquid crystal mixture of claim 1, wherein, in the compound (A), G¹ and G² independently represent 1,4-phenylene, 1,4-cyclohexylene, 3-fluoro-1,4-phenylene, 5-fluoro-1,4-phenylene, 3,5-difluoro-1,4-phenylene, or piperazinyl; Z¹ and Z² independently represent a single bond, —COO—, —OCO—, —CH₂CH₂—, —CH═CH—, —CH₂O—, —OCH₂—, —CF₂O—, or —OCF₂—; and R¹ represents R or RO, R being a linear or branched C₁-C₇ alkyl group, or a linear or branched C₂-C₇ alkyl group having an unsaturated bond.

4. The liquid crystal mixture of claim 3, wherein said compound (A) is selected from the group consisting of:

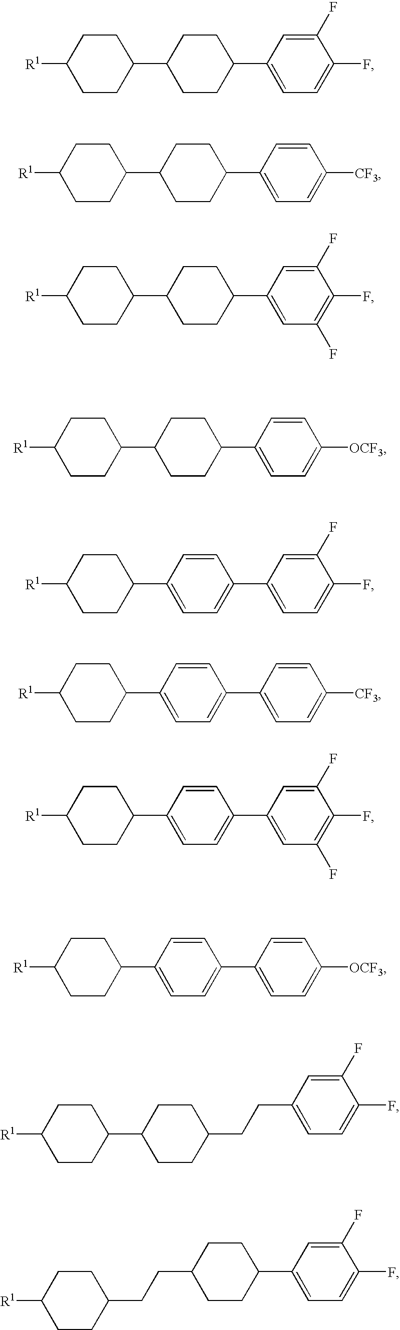

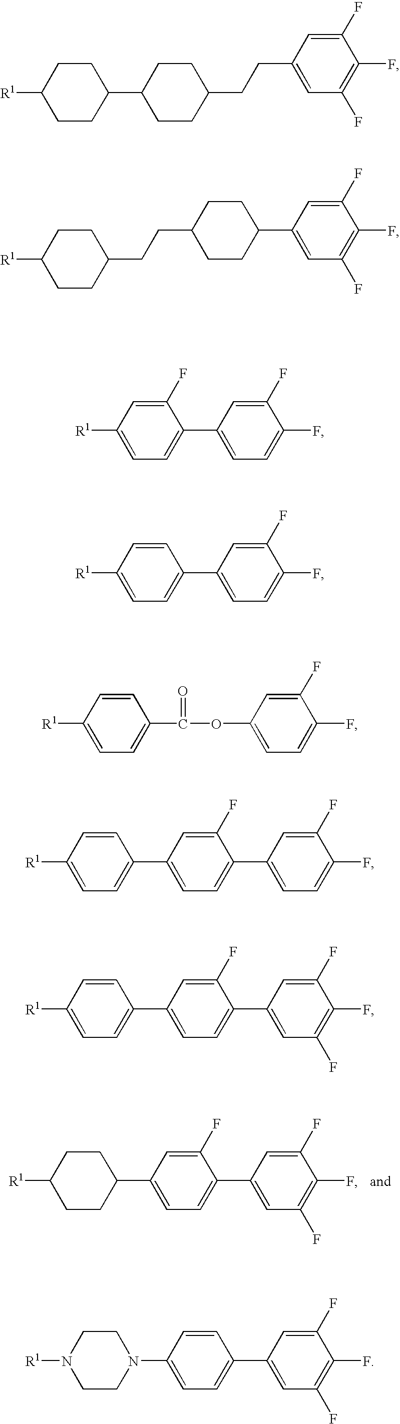

5. The liquid crystal mixture of claim 4, wherein said compound (A) is selected from the group consisting of:

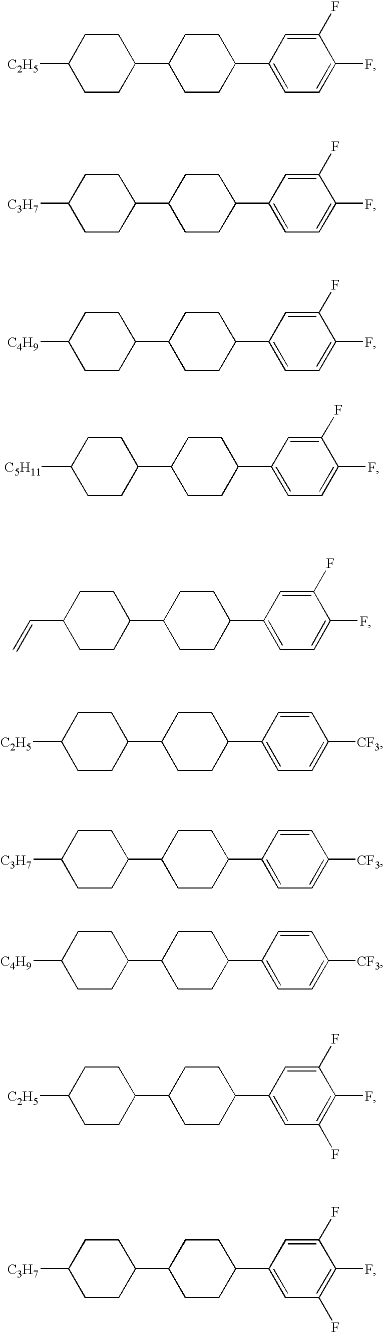

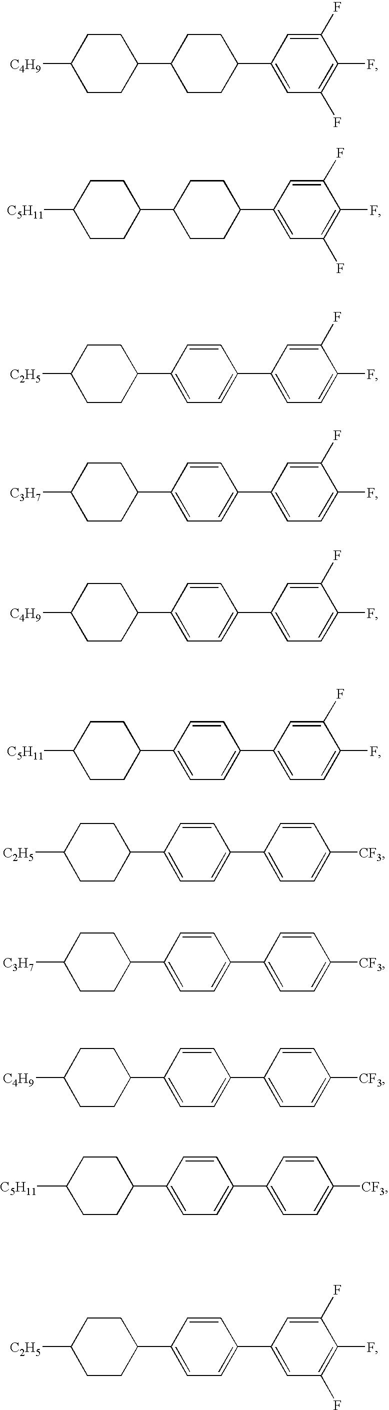

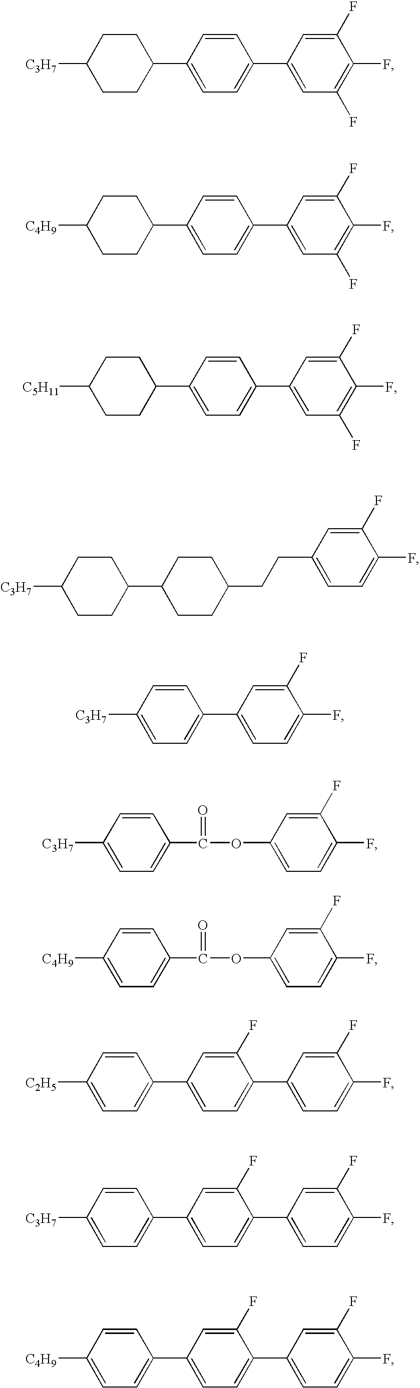

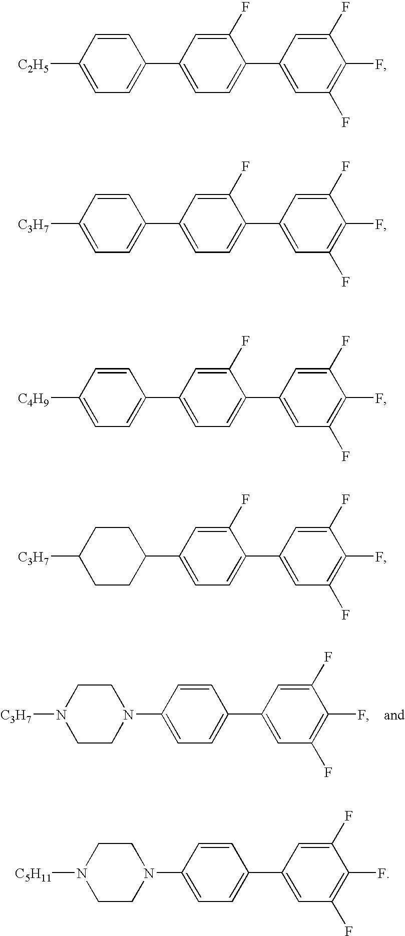

6. The liquid crystal mixture of claim 1, wherein, in the compound (B), G³ and G⁴ independently represent 1,4-phenylene, 1,4-cyclohexylene, 3-fluoro-1,4-phenylene, 5-fluoro-1,4-phenylene, or 3,5-difluoro-1,4-phenylene; Z⁴ is a single bond; and R² represents R or RO, R being a linear or branched C₁-C₇ alkyl group, or a linear or branched C₂-C₇ alkyl group having an unsaturated bond.

7. The liquid crystal mixture of claim 6, wherein said perfluoroallyloxy compound (B) is selected from the group consisting of:

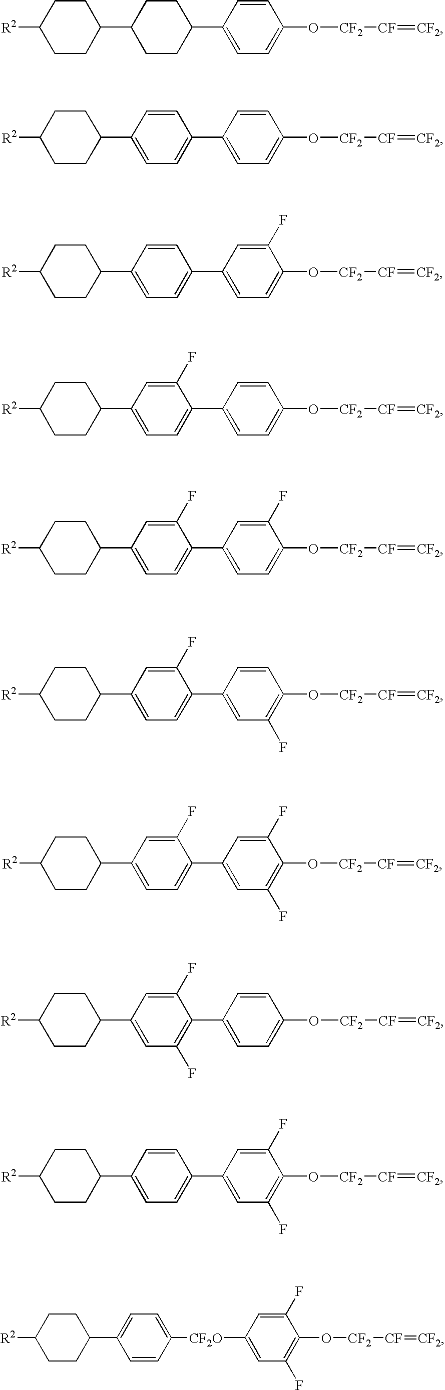

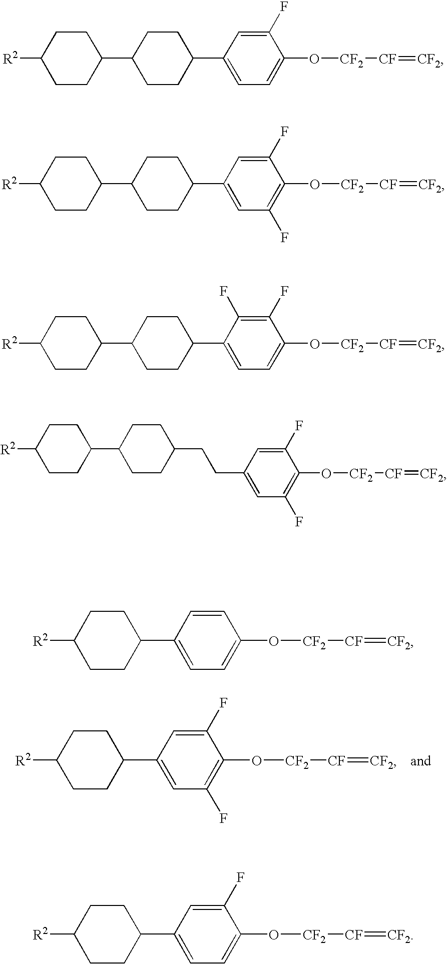

8. The liquid crystal mixture of claim 7, wherein said perfluoroallyloxy compound (B) is selected from the group consisting of:

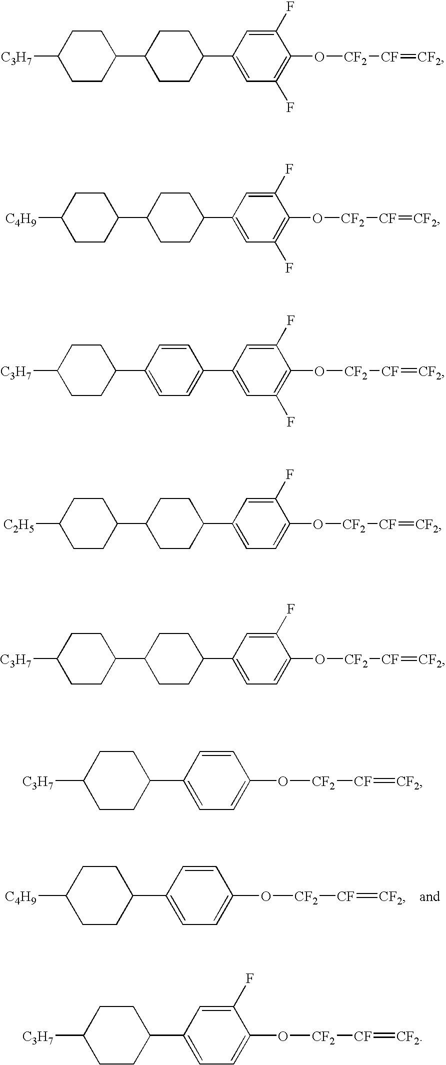

9. The liquid crystal mixture of claim 1, wherein, in the compound (C), G⁵ and G⁶ independently represent 1,4-phenylene, 1,4-cyclohexylene, 3-fluoro-1,4-phenylene, 5-fluoro-1,4-phenylene, or 3,5-difluoro-1,4-phenylene; G⁷ represents 1,4-phenylene or 1,4-cyclohexylene; and R³ represents R or RO, R being a linear or branched C₁-C₇ alkyl group, or a linear or branched C₂-C₇ alkyl group having an unsaturated bond.

10. The liquid crystal mixture of claim 9, wherein said compound (C) is selected from the group consisting of:

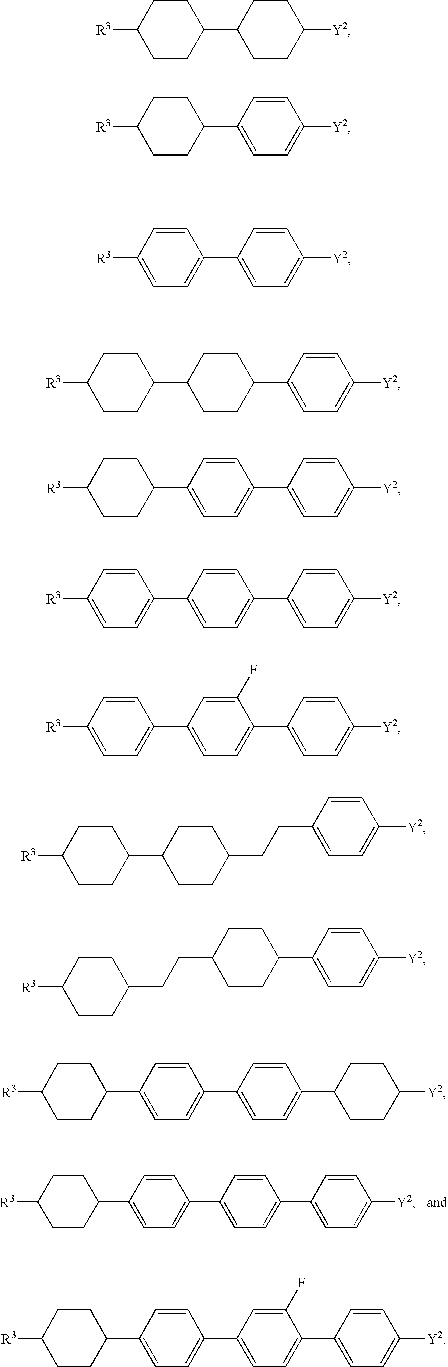

11. The liquid crystal mixture of claim 10, wherein said compound (C) is selected from the group consisting of: 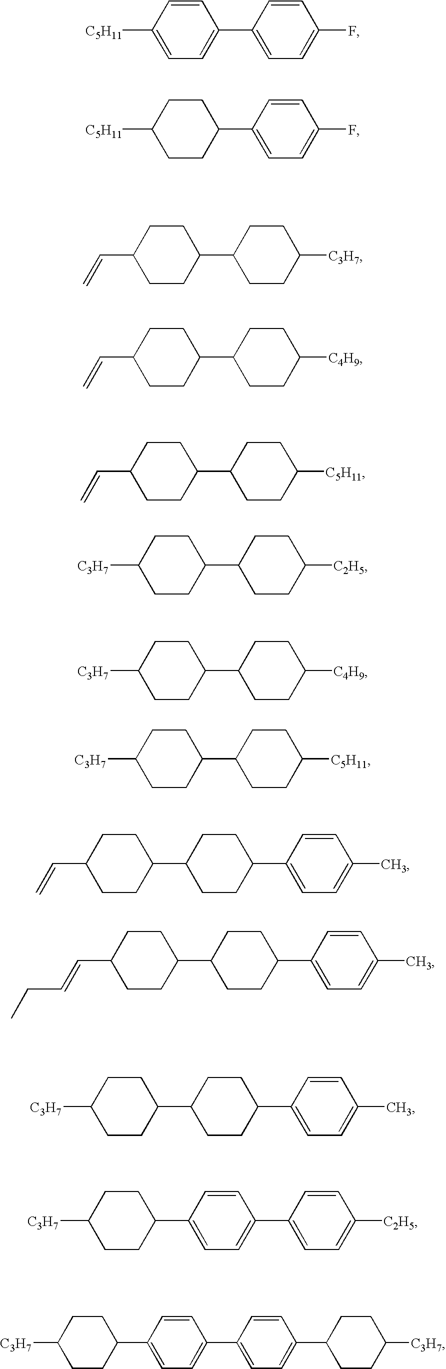 [chemical structure]
